(19) United States
(12) Patent Application Publication
(10) Pub. No.: US 2026/0265036 A1
(43) Pub. Date: Sep. 10, 2026

(54) ROBOTIC VEHICLE

(71) Applicant: Ocado Innovation Limited, Hatfield (GB)

(72) Inventors: Michael REILLY, Winthrop, MA (US); Jake COLLINS, Worcester, MA (US); Kurt BILIS, Cambridge, MA (US); Nicholas TANTISUJJATHAM, Cambridge, MA (US); Daryl VAN KAMPEN, Las Vegas, NV (US)

(21) Appl. No.: 19/075,523

(22) Filed: Mar. 10, 2025

(51) Int. Cl. B66F 17/00; B66F 9/06; B66F 9/12

(52) U.S. Cl. CPC B66F 17/003; B66F 9/063; B66F 9/122

(57) ABSTRACT

An example robotic vehicle includes a body, the body comprising a platform support area; a drive means configured to move the robotic vehicle on a surface; a lifting shuttle comprising an actuator, a first fork and a second fork; such that the robotic vehicle extends an end of the first and second forks to protrude from the body of the robotic vehicle; inserts at least a portion of the first and second forks into the interior of a platform; activates the actuator to cause the portion of the first and second forks to lift the platform; transfers the platform such that it is received on the platform support area; and activates the drive means to move the robotic vehicle to a further location, the activation of the drive means being dependent on the weight received on the platform support area.

### FIELD OF THE DISCLOSURE

This disclosure relates generally to a robotic vehicle and, more particularly, to movement controls for robotic vehicles.

### BACKGROUND

A robotic vehicle (e.g., a robotic truck) can include forks (also referred to as tynes or tines) to enable the vehicle to pick up and move object(s) (e.g., a pallet) in an environment such as a warehouse. A platform such as a pallet may be used in a warehouse to support goods and to enable the goods to be carried from one location to another while on the platform. The platform includes opening(s) or slot(s) to facilitate lifting of the platform by a vehicle such as a forklift truck. Platforms can vary in size, shape, weight, form factor, etc.

FIGS. 1A and 1B show a schematic depiction of a known robotic vehicle 100, with FIG. 1A showing a schematic representation of the robotic vehicle and FIG. 1B showing a depiction of some aspects of the robotic vehicle that are not shown in FIG. 1A. The example robotic vehicle 100 comprises a body 102 and a drive means 121 which may comprise one or more motors (e.g., electric motor(s) and/or other drive mechanism(s)) to cause movement of the body 102 via the wheel(s) of the robotic vehicle 100. The robotic vehicle 100 includes motor control circuitry 103 (e.g., hardware and/or software components) to control, for example, a speed of the robotic vehicle 100. One or more components of the motor control circuitry 103 can be implemented by processor circuitry 105 of the vehicle 100.

The robotic vehicle 100 can include an autonomous vehicle. The robotic vehicle 100 includes vehicle control circuitry 107 to control movement of the autonomous or self-driving robotic vehicle 100. One or more components of vehicle control circuitry 107 can be implemented by the processor circuitry 105 of the robotic vehicle 100, processor circuitry of another user device, and/or cloud-based device(s). The robotic vehicle 100 moves to a location in an environment (e.g., a warehouse) without or with limited user input control during movement of the vehicle 100.

In some examples, the robotic vehicle 100 includes a display screen 109 to present data to user(s) of the robotic vehicle 100. In some examples, the robotic vehicle 100 includes speaker(s) to provide audio output(s) to user(s) interacting with the robotic vehicle 100. The example robotic vehicle 100 of FIGS. 1A-1B includes a power source 111 such as a battery to provide power to the components of the robotic vehicle 100.

In the example of FIGS. 1A-1B, the body 102 of the robotic vehicle 100 defines a housing 104 and a platform support area 106. The example robotic vehicle 100 includes a lifting shuttle 108 that is moveable relative to the platform support area 106 from a first or stored position to a second or protruded position. The lifting shuttle 108 includes an actuator support 110, a first fork 112, and a second fork 114. The platform support area 106 can define openings defined by sidewalls of the body 102 that include tracks or rails to receive the forks 112, 114 and facilitate movement of the lifting shuttle 108. The platform support area 106 can include, for example, a rack and pinion or chains to drive movement of the lifting shuttle 108 (e.g., the push or pull the forks 112, 114 relative to the platform support area 106). As disclosed herein, the actuator support 110 supports actuator(s), which cause lifting legs of the forks 112, 114 to deploy to lift a platform 116 (e.g., a pallet). The actuator support 110 can also serve as a counterweight to facilitate stability of the vehicle 100 when the forks 112, 114 are extended relative to the vehicle body 102. The actuator support 110 can be disposed in the housing 104 of the vehicle 100 when not in use and/or when the platform 116 is carried by the platform support area 106.

In the example of FIGS. 1A-1B, the platform support area 106 includes sensor(s) 118 to detect when the vehicle 100 is proximate to the platform 116. In some examples, the lifting shuttle 108 additionally or alternatively includes the sensor(s) 118 (e.g., located on the actuator support 110, on the fork(s) 112, 114). The sensor(s) 118 can include, for example, image sensor(s), proximity sensor(s), infrared sensor(s), LIDAR sensor(s), etc.

In the example of FIGS. 1A-1B, the outputs of the sensor(s) 118 are analyzed by lifting control circuitry 120. One or more components of lifting control circuitry 120 can be implemented by the processor circuitry 105 of the robotic vehicle 100, processor circuitry of another user device, and/or cloud- based device(s). Based on the outputs of the sensor(s) 118, the lifting control circuitry 120 detects when the vehicle 100 is proximate to the platform 116. In particular, the lifting control circuitry 120 detects when the body 102 of the vehicle 100 is aligned with the platform 116 such that when the forks 112, 114 extend relative to the body 102, the forks 112, 114 enter slot(s) or opening(s) 122 of the platform 116.

According to a first aspect of the present disclosure there is provided a robotic vehicle comprising: a body, the body comprising a platform support area, a drive means configured, in use, to move the robotic vehicle on a surface; a lifting shuttle comprising an actuator, a first fork and a second fork; wherein in use the robotic vehicle is configured to; extend an end of the first and second forks to protrude from the body of the robotic vehicle; insert at least a portion of the first and second forks into the interior of a platform; activate the actuator to cause the portion of the first and second forks to lift the platform; move relative to the platform such that the platform is received above the platform support area; retract the first and second lifting legs of the first and second forks such that the platform is received on the platform support area; and activate the drive means to move the robotic vehicle to a further location, the activation of the drive means being dependent on the weight received on the platform support area.

In one example, the robotic vehicle may be accelerated at a predetermined rate. Alternatively, or in addition, the robotic vehicle may be accelerated to a predetermined speed.

By operating a fleet of robotic vehicles such that they accelerate at the same rate (or at substantially the same rate) and/or such that each vehicle of the fleet of robotic vehicles move at the same speed (or at substantially the same speed) provides significant advantages. An unladen robotic vehicle will take substantially the same time to travel the same distance within a warehouse (or other similar storage environment) as a moderately or heavily loaded robotic vehicle. This greatly simplifies the orchestration of movement of the fleet of vehicles, path planning, etc. within the warehouse.

In one example, the actuator may comprise a measuring element, such that the data received from the measuring element can be used to determine the weight received on the platform support area. For example, the actuator may comprise an integrated load cell. The weight received on the platform support area may comprises the weight of the platform and any payload received on the platform.

According to a second aspect of the present disclosure there is provided a method of operating a robotic vehicle comprising a body, the body comprising a platform support area; a drive means configured, in use, to move the robotic vehicle on a surface; a lifting shuttle comprising an actuator, a first fork and a second fork; the method comprising: extending an end of the first and second forks to protrude from the body of the robotic vehicle; inserting at least a portion of the first and second forks into the interior of a platform; activating the actuator to cause the portion of the first and second forks to lift the platform; moving relative to the platform such that the platform is received above the platform support area; retracting the first and second lifting legs of the first and second forks such that the platform is received on the platform support area; and activating the drive means to move the robotic vehicle to a further location, the activation of the drive means being dependent on the weight received on the platform support area.

Activating the drive means may cause the robotic vehicle to accelerate at a predetermined rate. Activating the drive means may cause the robotic vehicle to be accelerated to a predetermined speed

According to a third aspect of the present disclosure there is provided non-transitory machine readable storage medium comprising machine-readable instructions that cause at least one processor circuit to control a robotic vehicle, the robotic vehicle comprising a body, the body comprising a platform support area; a drive means configured, in use, to move the robotic vehicle on a surface; a lifting shuttle comprising an actuator, a first fork and a second fork; to extend an end of the first and second forks to protrude from the body of the robotic vehicle; insert at least a portion of the first and second forks into the interior of a platform; activate the actuator to cause the portion of the first and second forks to lift the platform; move relative to the platform such that the platform is received above the platform support area; retract the first and second lifting legs of the first and second forks such that the platform is received on the platform support area; and activate the drive means to move the robotic vehicle to a further location, the activation of the drive means being dependent on the weight received on the platform support area.

### BRIEF DESCRIPTION OF THE DRAWINGS

FIGS. 1A and 1Bshow a schematic depiction of a known robotic vehicle which is configured to lift pallets;

FIGS. 2-4 show a schematic depiction of a lifting system of a robotic vehicle according to the present disclosure;

FIG. 5 shows a schematic depiction of an example implementation of the lifting control circuitry of a robotic vehicle according to the present disclosure;

FIG. 6 shows a schematic depiction of a flow chart depicting a method according to the present disclosure; and

FIG. 7 shows a schematic depiction of a computer device.

In general, the same reference numbers will be used throughout the drawing(s) and accompanying written description to refer to the same or like parts. The figures are not necessarily to scale.

### DETAILED DESCRIPTION

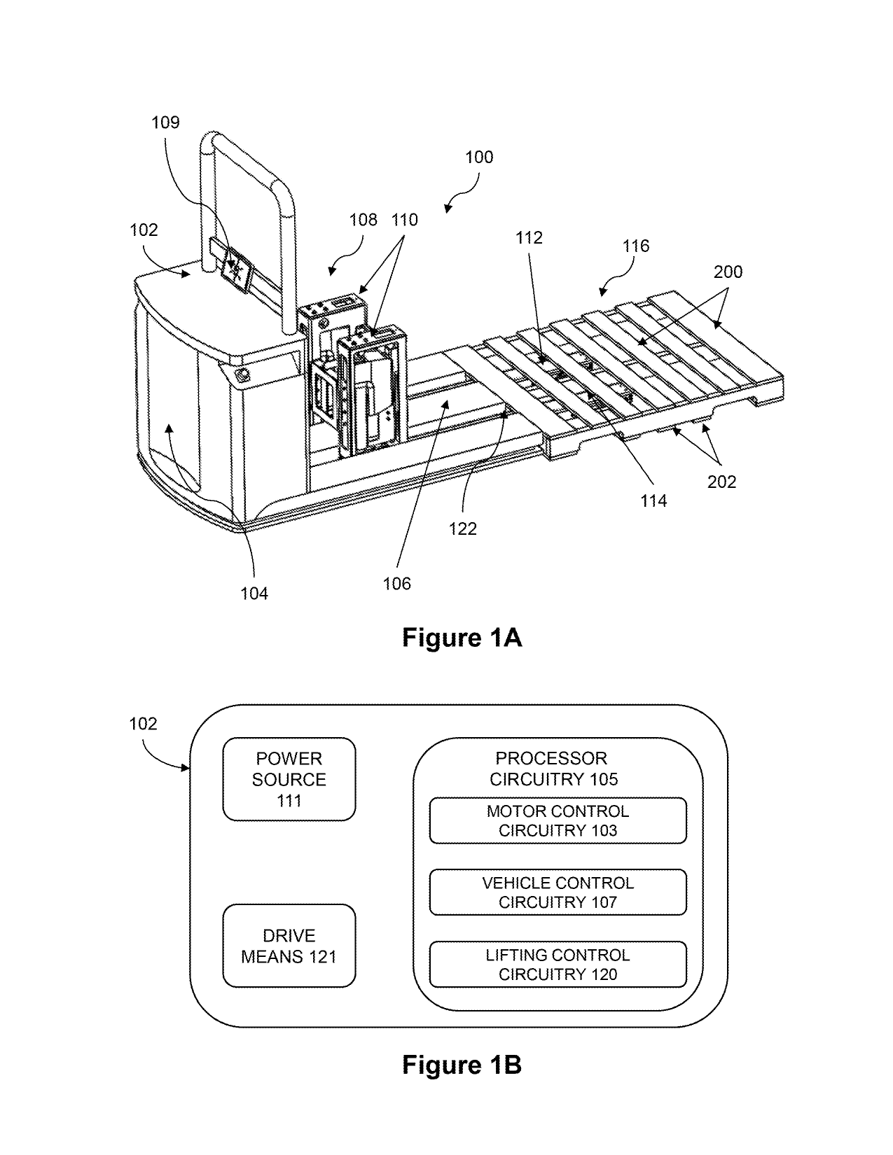

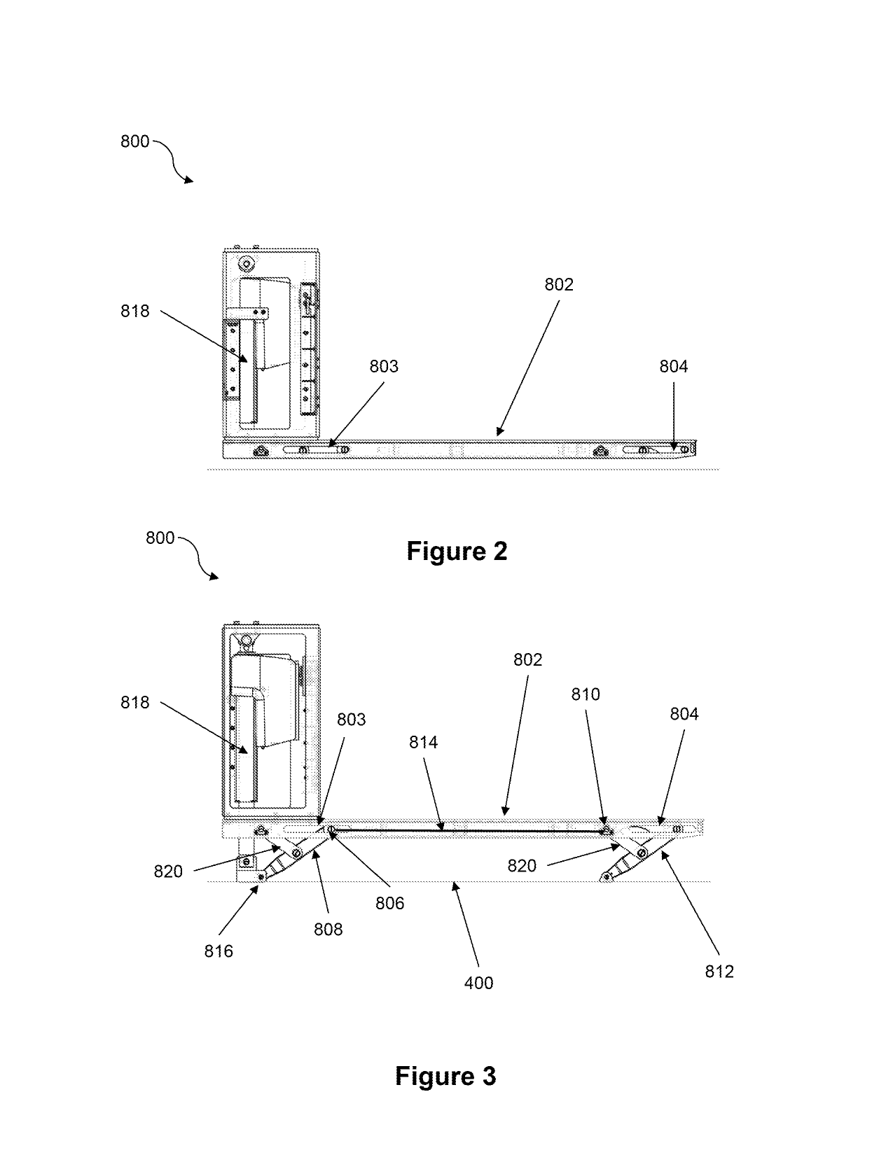

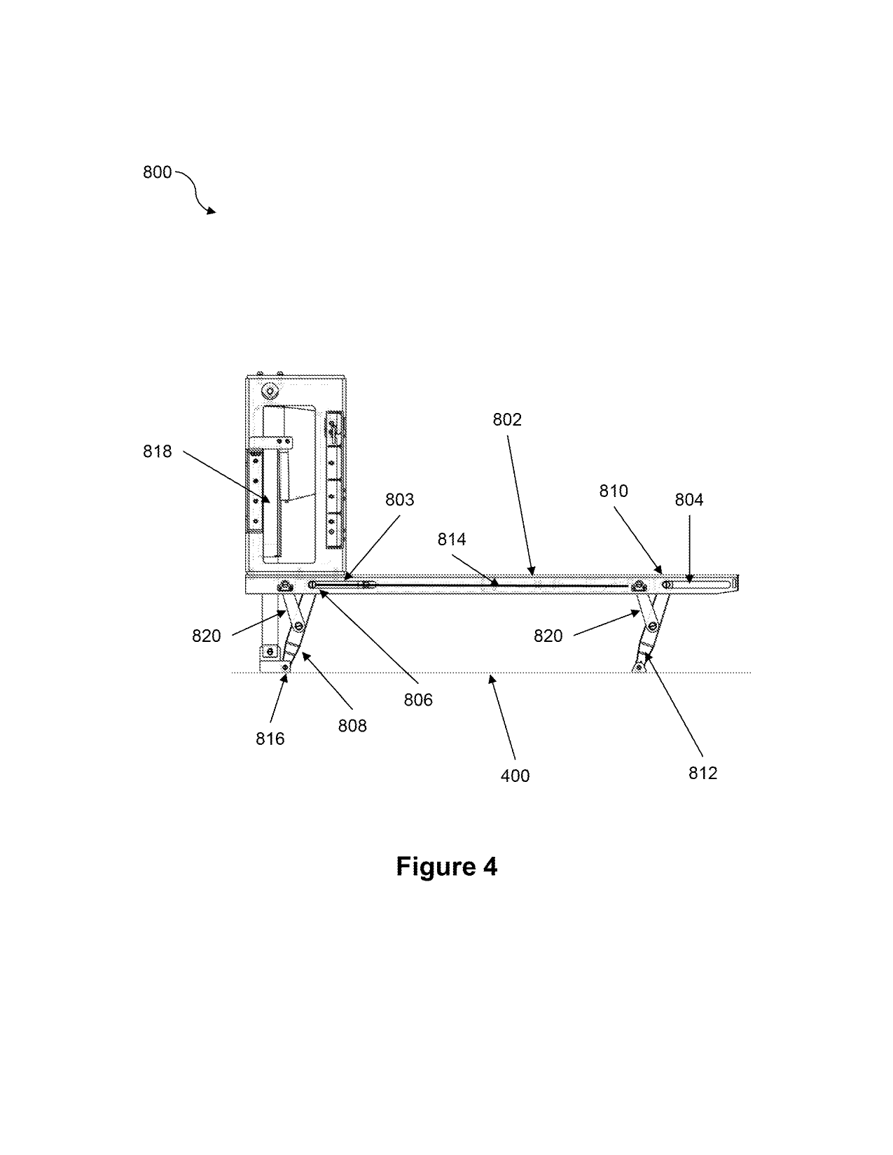

FIGS. 2-4 show a schematic depiction of a lifting system 800 of a robotic vehicle 100’ according to the present disclosure. It should be understood that the robotic vehicle 100’ is similar to that described above with reference to FIGS. 1A-1B.

A fork 802 (e.g., the fork 112, 114 of FIG. 1A) includes a first channel 803 and a second channel 804. A first end 806 of a first lifting leg 808 (e.g., one of the lifting legs 300 of the respective forks 112, 114) is disposed in the first channel 803 and a first end 810 of a second lifting leg 812 (e.g., the other one of the lifting legs 300 of the respective forks 112, 114) is disposed in the second channel 804. The first end 806 of the first lifting leg 808 is coupled to the first end 810 of the second lifting leg 812 via a connector 814 carried by the fork 802. A second end 816 of the first lifting leg 808 is coupled to an actuator 818. The actuator 818 can include, for example, an electronic cylinder (e.g., a linear actuator). In some examples, the actuator 818 is a hydraulic-based actuator or a pneumatic actuator. The actuator 818 can be supported by the actuator support 110 of FIG. 1A. Although in the example of FIG. 2 each of the lifting systems 800 associated with the respective forks 802 (e.g., the forks 112, 114) includes one actuator 818, in other examples, the robotic vehicle may comprise two actuators. In such an example a first actuator may be used to control the movement of the two lifting legs 300 of the first fork 112 and a second actuator may be used to control the two lifting legs 300 of the second fork 114.

As shown in FIGS. 2-4, activation of the actuator 818 causes the first lifting leg 808 to move from a retracted position to an extended position via movement of second end 816 of the first lifting leg 808, which pulls the first end 806 of the first lifting leg 808 along the first channel 803. As the first lifting leg 808 extends, the movement of the first end 806 of the first lifting leg 808 pulls the first end 810 of the second lifting leg 812 along the second channel 804 via the connector 814, which causes the second lifting leg 812 to extend. The example lifting system 800 includes linkages 820 to support and/or facilitate movement of the lifting legs 808, 812 relative to the fork 802. Thus, the example lifting system 800 transfers force horizontally via the channels 803, 804 and along the fork 802. As a result, each of the lifting legs 808, 812 provide equal or substantially equal lifting force to raise the fork 802 and the platform 116. Further, the legs 808, 812 and the linkages 820 are sized such that when the legs 808, 812 are retracted, the fork 802 (including the legs 808, 812 and the linkages 820) fits through the opening(s) 122 of the platform 116 without interference.

Although examples disclosed herein are discussed in connection with loading and unloading pallets, the example lifting systems disclosed herein can be used for other purposes such as raising a vehicle chassis for maintenance purposes.

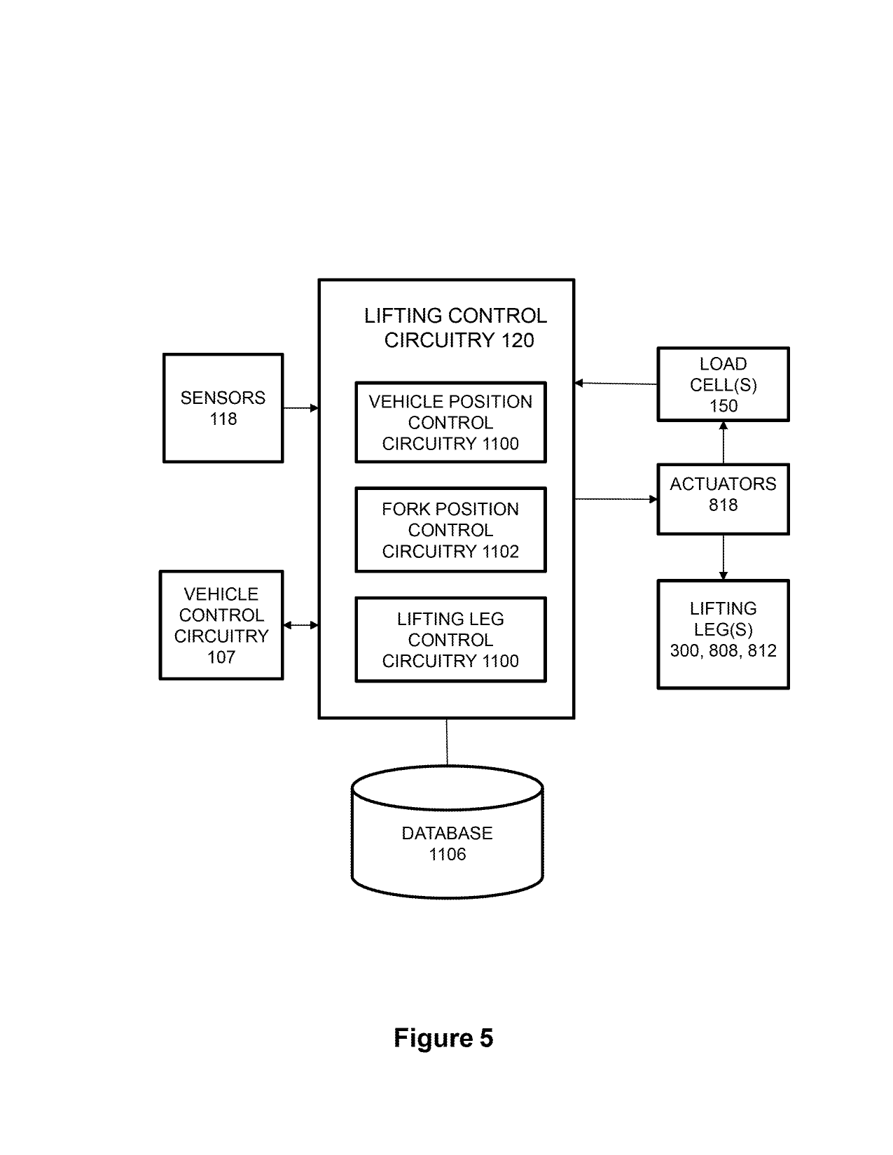

FIG. 5 is a block diagram of an example implementation of the lifting control circuitry 120 of FIG. 1B to control loading or unloading of the platform 116 relative to the platform loading area 106 of the robotic vehicle 100 of FIG. 1A. The example lifting control circuitry 120 of FIG. 5 includes vehicle position control circuitry 1100, fork position control circuitry 1102, and lifting leg control circuitry 1104. In some examples, the vehicle position control circuitry 1100 is instantiated by programmable circuitry executing vehicle position control instructions. In some examples, the fork position control circuitry 1102 is instantiated by programmable circuitry executing fork position control instructions. In some examples, the lifting leg control circuitry 1104 is instantiated by programmable circuitry executing lifting leg control instructions. The lifting control circuitry 120 is communicably connected to a database 1106 which holds data generated by the vehicle sensors, or by other means. The database 1106 may further hold one or more rules for sensor data analysis, one or more rules relating to the extension and/or movement of the lifting legs, one or more rules relating to the positioning of the robotic vehicle, etc. The operation of a lifting mechanism is disclosed in WO2024/240940, the contents of which are hereby disclosed in their entirety by reference.

The or each actuator 818 of the robotic vehicle 100’ has a respective load cell. When the lifting system 800 is activated to lift a pallet then the load cell will measure the load applied by the actuator(s). This data can be fed to the lifting control circuitry 120 such that the weight of the pallet and any load received thereon can be determined. This weight data can be transmitted to the vehicle control circuitry such that the movement of the loaded robotic vehicle can be determined in accordance with the weight of the loaded vehicle. For example, a typical unladen robotic vehicle may weigh approximately 500 kg whilst a fully loaded robotic vehicle may weigh 2000 kg.

It can be seen that if the same force is applied to an unladen robotic vehicle and a fully laden robotic vehicle then the unladen robotic vehicle will accelerate significantly faster than the fully laden vehicle. This difference may mean that an unladen robotic vehicle is able to move at higher average speeds in a storage environment such as a warehouse. This means that an unladen robotic vehicle may be able to move between a first location and a second location in a storage environment in significantly less time than a fully laden robotic vehicle.

When operating a fleet of robotic vehicles it is preferred that each robotic vehicle:

accelerates at substantially the same rate

operates at substantially the same constant speed once the acceleration phase has ended and

decelerates at substantially the same rate

If each robotic vehicle operates consistently in respect of acceleration, speed and deceleration then this assists in the operation of the fleet of robotic vehicles, as workflows, tasks, paths for the robotic vehicles etc. can be planned on the basis of the consistent and repeatable movement of the robotic vehicles. If the robotic vehicles were to apply the same force when accelerating from a stationary position then the risk of an unladen (or lightly loaded) robotic vehicle catching up with a heavily loaded robotic vehicle is increased, leading to an increased risk of collisions. Furthermore, if the robotic vehicles move at consistent speeds, then this increases the safety of human operators which are working alongside such robotic vehicles.

In one example, the vehicle control circuitry 107 may determine the force to be applied by the drive means 121 in accordance with the measured weight of the pallet and any payload received on the pallet. Thus, the acceleration of the robotic vehicle and the maximum speed of the robotic vehicle is substantially the same, regardless of the payload (if any) carried by the robotic vehicle.

In another example, the vehicle control circuitry 107 may select one or of a number of predetermined profiles in accordance with the measured weight of the pallet and any payload received on the pallet. The number of profiles will vary the maximum payload of the robotic vehicle, such that the acceleration of the robotic vehicle and the maximum speed of the robotic vehicle is substantially the same, regardless of the payload (if any) carried by the robotic vehicle.

An example of an actuator which comprises a load cell is the XD48B160-0250COO-MMMN linear actuator which is manufactured by Thomson. It will be understood that other actuators which incorporate a load cell may be used as an alternative.

In a further alternative, other methods may be used to determine the weight that is being carried by a robotic vehicle. For example, one or more weight sensors may be received under the platform support area such that the weight of a pallet and the associated payload may be determined. Alternatively, one or more sensors may be received elsewhere in the vehicle such that the weight loaded onto the robotic vehicle may be determined.

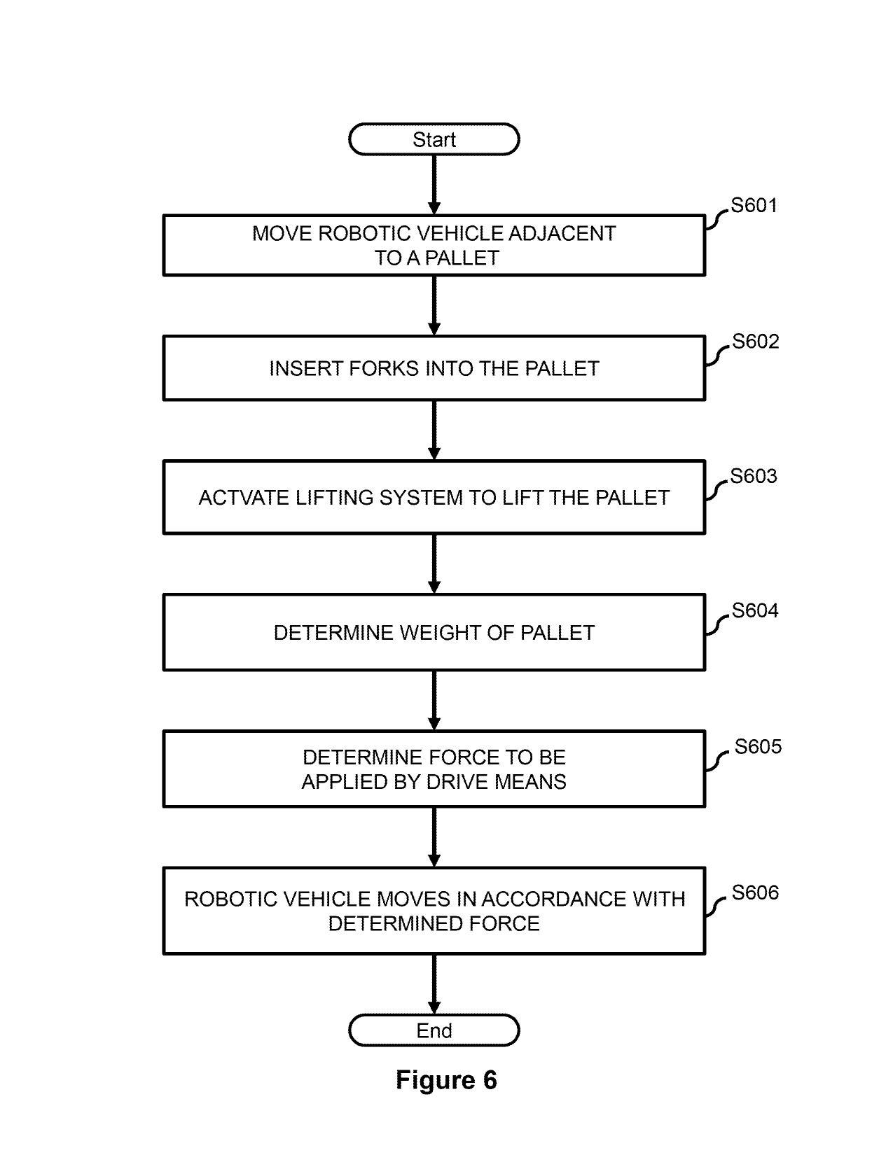

FIG. 6 shows a schematic depiction of a flow chart depicting a method according to the present disclosure. The method starts at S601 where the robotic vehicle moves autonomously to a location which is adjacent to a pallet to be lifted. At S602 the robotic vehicle inserts the forks into the interior of the pallet and then at S603 the lifting system of the robotic vehicle may be activated to lift the pallet and any load received thereon. The weight of the pallet and any payload is determined S604, for example in accordance with data received from the one or more load cells. At S605 the force to be applied by the drive means of the robotic vehicle is determined in accordance with the pallet weight determined at S604. The determination of the force to be applied by the drive means of the robotic vehicle may comprise a selection of one or more pre-determined force profiles. The robotic vehicle will then move in accordance with the force determined at S605, after which the process ends. It should be understood that the robotic vehicle will operate using that determined force or (force profile) until the pallet is unloaded from the robotic vehicle using the lifting system. After the robotic vehicle has unloaded a pallet then the robotic vehicle may select a drive means force (or force profile) which is appropriate for an unladen robotic vehicle such that it moves at substantially the same speed (and accelerates at substantially the same rate) as a moderately (or heavily) laden robotic vehicle.

The lifting control circuitry 120 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the lifting control circuitry 120 of FIG. 5 may be instantiated by an Application Specific Integrated Circuit (ASIC) and/or (ii) a Field Programmable Gate Array (FPGA) structured and/or configured in response to execution of second instructions to perform operations corresponding to the first instructions, or other equivalent arrangements. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

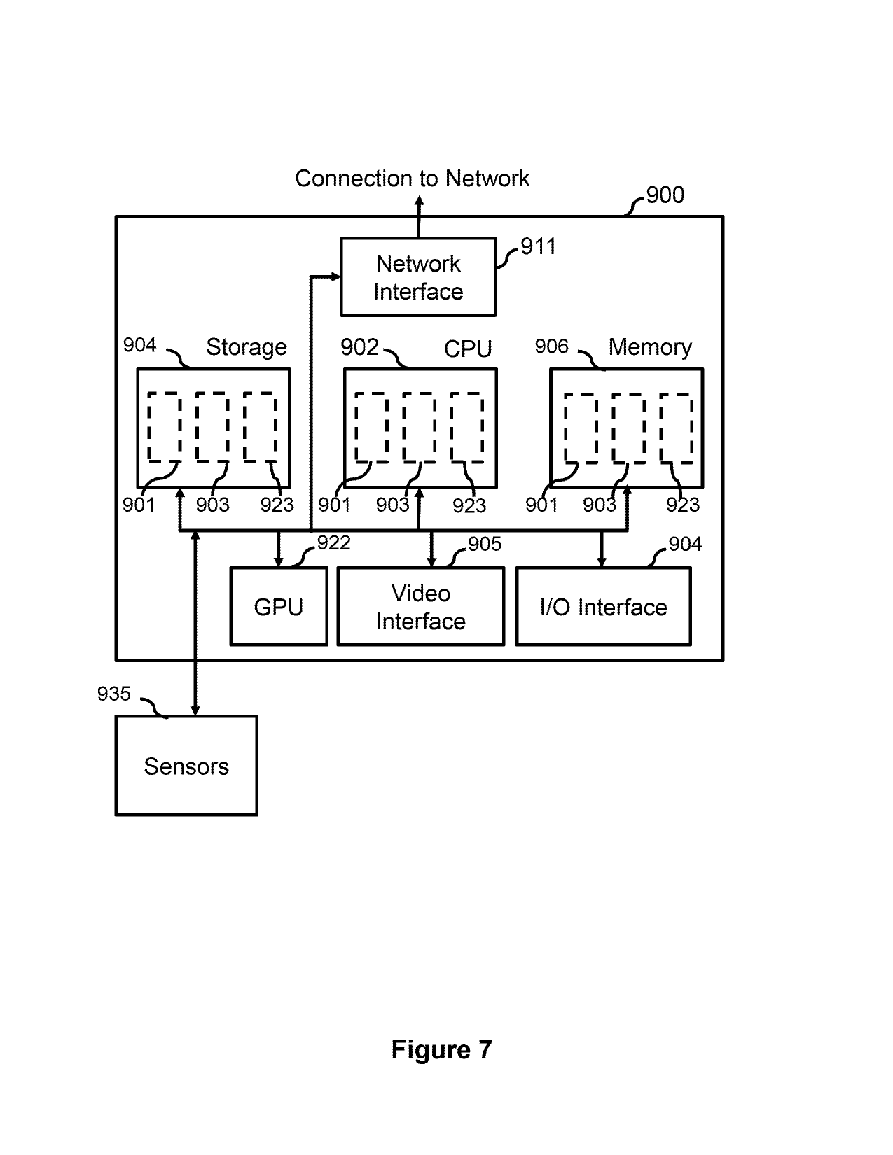

It will be understood that a robotic vehicle according to the present disclosure may comprise one or more computing devices, for example for instantiating the processor circuitry 105. FIG. 7 shows a schematic depiction of a computer device 900 that may include a central processing unit (“CPU”) 902 connected to a storage unit 914 and to a random access memory 906. The CPU 902 may process an operating system 901, application program 903, and data 923. The operating system 901, application program 903, and data 923 may be stored in storage unit 914 and loaded into memory 906, as may be required. Computer device 900 may further include a graphics processing unit (GPU) 922 which is operatively connected to CPU 902 and to memory 906 to offload intensive image processing calculations from CPU 902 and run these calculations in parallel with CPU 902. The computing device may further comprise a network interface 911, for example a Wi-Fi interface or a cellular interface (for example, an interface using LTE technology), to communicate with a warehouse management system and/or other systems operating in the storage environment in which the robotic vehicle operates. The computer device 900 may receive data from one or more sensors 935. These sensors may comprise the one or more cameras received within the robotic vehicle, and any other sensors which may be comprised within the robotic vehicle. Data generated by one or more further sensors may also be received by the computer device and used to control the movement and operation of the robotic vehicle.

In one respect there is provided a robotic vehicle which includes a body, the body comprising a platform support area; a drive means configured to move the robotic vehicle on a surface; a lifting shuttle comprising an actuator, a first fork and a second fork; such that the robotic vehicle extends an end of the first and second forks to protrude from the body of the robotic vehicle; inserts at least a portion of the first and second forks into the interior of a platform; activates the actuator to cause the portion of the first and second forks to lift the platform; transfers the platform such that it is received on the platform support area; and activates the drive means to move the robotic vehicle to a further location, the activation of the drive means being dependent on the weight received on the platform support area.

1. A robotic vehicle comprising:
a body, the body comprising a platform support area;
a drive means configured, in use, to move the robotic vehicle on a surface;
a lifting shuttle comprising an actuator, a first fork and a second fork;
wherein in use the robotic vehicle is configured to;
extend an end of the first and second forks to protrude from the body of the robotic vehicle;
insert at least a portion of the first and second forks into the interior of a platform;
activate the actuator to cause the portion of the first and second forks to lift the platform;
move relative to the platform such that the platform is received above the platform support area;
retract the first and second lifting legs of the first and second forks such that the platform is received on the platform support area; and
activate the drive means to move the robotic vehicle to a further location, the activation of the drive means being dependent on the weight received on the platform support area.

2. A robotic vehicle according to claim 1, wherein the robotic vehicle is accelerated at a predetermined rate.

3. A robotic vehicle according to claim 1, wherein the robotic vehicle is accelerated to a predetermined speed.

4. A robotic vehicle according to claim 1, wherein the actuator comprises a measuring element, such that the data received from the measuring element can be used to determine the weight received on the platform support area.

5. A robotic vehicle according to claim 1, wherein the weight received on the platform support area comprises the weight of the platform and a payload received on the platform.

6. A method of operating a robotic vehicle comprising a body, the body comprising a platform support area; a drive means configured, in use, to move the robotic vehicle on a surface; a lifting shuttle comprising an actuator, a first fork and a second fork; the method comprising:
extending an end of the first and second forks to protrude from the body of the robotic vehicle;
inserting at least a portion of the first and second forks into the interior of a platform;
activating the actuator to cause the portion of the first and second forks to lift the platform;
moving relative to the platform such that the platform is received above the platform support area;
retracting the first and second lifting legs of the first and second forks such that the platform is received on the platform support area; and
activating the drive means to move the robotic vehicle to a further location, the activation of the drive means being dependent on the weight received on the platform support area.

7. A method according to claim 6, wherein activating the drive means causes the robotic vehicle to be accelerated at a predetermined rate.

8. A method according to claim 6, wherein activating the drive means causes the robotic vehicle to be accelerated to a predetermined speed.

9. A method according to claim 6, wherein the actuator comprises a measuring element, such that the data received from the measuring element can be used to determine the weight received on the platform support area.

10. A non-transitory machine readable storage medium comprising machine-readable instructions that cause at least one processor circuit to control a robotic vehicle, the robotic vehicle comprising a body, the body comprising a platform support area; a drive means configured, in use, to move the robotic vehicle on a surface; a lifting shuttle comprising an actuator, a first fork and a second fork; to
extend an end of the first and second forks to protrude from the body of the robotic vehicle;
insert at least a portion of the first and second forks into the interior of a platform;
activate the actuator to cause the portion of the first and second forks to lift the platform;
move relative to the platform such that the platform is received above the platform support area;
retract the first and second lifting legs of the first and second forks such that the platform is received on the platform support area; and
activate the drive means to move the robotic vehicle to a further location, the activation of the drive means being dependent on the weight received on the platform support area.
